(19) United States
(12) Patent Application Publication
(10) Pub. No.: US 2020/0313887 A1
(43) Pub. Date: Oct. 1, 2020

(54) Micoservices Based Mainchain/Sidechain (MMS) Architecture For Blockchain

(71) Applicant: Si Yin, Sunnyvale, CA (US)

(72) Inventor: Si Yin, Sunnyvale, CA (US)

(73) Assignee: Si Yin, Sunnyvale, CA (US)

(21) Appl. No.: 16/365,658

(22) Filed: Mar. 26, 2019

(51) Int. Cl. H04L 9/32; G06Q 20/38; G06Q 20/06

(52) U.S. Cl. CPC H04L 9/32; G06Q 20/389; H04L 2209/56; H04L 2209/38; G06Q 20/0658

(57) ABSTRACT

The subject invention is a new Micoservices based Mainchain/Sidechain (MMS) architecture, which is a four-layer architecture including mainchian layer, microservices core layer, sidechain layer and DApps layer, to solve the issues of the traditional public blockchain platform. To illustrate the implementation of MMS, the subject invention also gives one possible implementation scenario of MMS by creating different side chains including Management Sidechain, System Service Sidechain, and Ecosystem Sidechain. Finally, the subject invention also presents method for a for cross-chain communication mechanism among MMS.

### RELATED APPLICATION INFORMATION

This application claims priority to provisional application Ser. No. 62/648,386 filed on Mar. 26, 2018, entitled “A New Micoservices Based Mainchain/Sidechain (MMS) Architecture For Blockchain”, incorporated herein by reference.

### BACKGROUND OF THE INVENTION

### Field of the Invention

Recently, the explosion of decentralized application development in the blockchain community has a huge demand for a fast, robust, secure and easy-to-use public blockchain platform. However, current public blockchain infrastructure such as Ethereum has many issues yet to be solved to fulfill the above requirements. These issues include but not limited to: inability to handle miscellaneous data, performance constraint of the single chain structure, inefficient system upgrading etc.

### Related Art

The traditional public blockchain platform is not designed for high speed, high performance commercial application. For example, if users want to provide various of services including monetary fund management, issuing data currency, trading transaction certification, legal consulting, these services have completely different service interfaces, data format, contract format, for traditional public blockchain platform to handle. For in instance, each of the services will have its own metadata, management targets, transaction principle, and iff all of these data are mounted on a single chain, like the traditional Ethereum does, the potential issues are multi-folded:

a. Chain Length Explosion.

Because of the nature of PoW in the traditional public blockchain platform, the number of transactions in each block is likely to be small. With all transactions recorded on the mainchain, the traditional public blockchain platform will run out of total asset in a short time.

b. Impossible Access Control.

Different services might have different users and group permissions. This will also be applicable to the granularity of the data access and user authentication.

c. Hard Chain Upgrade and New Service Registration.

The traditional public blockchain platform will not be completed in the first version. Instead, new features and services will keep coming up in new releases. Without sidechain, new features and services cannot be rolled out incrementally. Any unforeseen issue will impact all services at the same time.

### BRIEF SUMMARY OF THE INVENTION

The subject invention is a new Micoservices based Mainchain/Sidechain (MMS) architecture, which is a four-layer architecture including mainchian layer, microservices core layer, sidechain layer and DApps layer, to solve the issues of the traditional public blockchain platform. To illustrate the implementation of MMS, the subject invention also gives one possible implementation scenario of MMS by creating different side chains including Management Sidechain, System Service Sidechain, and Ecosystem Sidechain. Finally, the subject invention also presents method for a for cross-chain communication mechanism among MIMS.

### BRIEF DESCRIPTION OF THE DRAWINGS

FIG. 1. FIG. 1 shows the overall architecture of Microservices based Main Chain/Side Chain (MMS)

FIG. 2. FIG. 2 illustrates the side chain implementation and its relationship to the mainchain and microservices in MMS

### DETAILED DESCRIPTION AND BEST MODE OF IMPLEMENTATION

The invention covers three aspects of MMS: MMS architect, MMS sidechain implementation, and MMS operations.

### 1. MMS Architect:

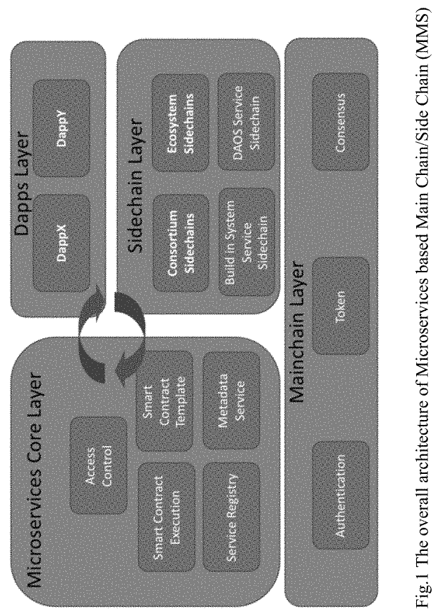

Referring now to the invention in more detail, in FIG. 1, MMS has four-layer architecture:
Layer 1: Mainchain layer
Layer 2: Microservices core layer
Layer 3: Sidechains layer
Layer 4: Dapps layer

Where the mainchain layer is the backbone layer for MMS. Dapps layer is built on top of sidechain layer, and both layers are in parallel to the microservices core layer and are both able to communicate with microservices core layer directly via REST APIs.

### 1.1 Mainchain Layer

To well decoupled the functionality of services, all services provided by MMS will be on sidechains. As a result, the major usages of the mainchain is to record all blockchain transactions plus providing basic infrastructure of MMS, such as Authentication and Consensus mechanism. We will illustrate them as below:

a. Authentication Mechanism Module

In the mainchain, we will use general ECC for cryptophytic purpose.

b. Consensus Mechanism Module

MMS uses the following consensus mechanism to process the consensus. Some high-level principles are listed below:
1). The Virtual machines (VMs) are created by the smart contract for mining and delegation purpose.
2). VMs are put into different categories based on different computing power, and put into the candidate pool.
3). VMs from each category are selected as the delegates and put into the delegates cluster pool, and ensure the sum of share hold represented by the VMs are more than 50% of the total share hold.
4). Divide the time spectrum into N slots. In each time slot, allocate same number of time windows for VMs in each category to perform the mining of the new block.
5). Essentially, the consensus method gives each delegate an equal opportunity to participate the mining process regardless the computing power of the delegate.

Furthermore, the delegate with higher computing power will process more transitions request (thus more blocks) and generate more rewards to the shareholder with higher share stake, even it was given equal process time comparing with other delegates with lower computing power.

c. Token Module

Similar to the concept of “Gas” in the Ethereum, MMS use its own token to fuel the transaction and provide rewards as incentive for miners. Token module is used to manage and record the token transactions.

### 1.2 Microservices Core Layer

Mircroservices is an architecture style, in which large complex software applications are composed of one or more services. The main characteristics of Microservices are 1) highly Modulated. Service A does not need to know the implementation detail of another service B before them can communicate; 2) services are independently deployed with loosely coupled. 3) The communication among services are usually through REST API. Here in MMS, as sidechains share a lot of common characteristics and require a set of common services, we design the microservcies core layer to provide shared services such as service registry, metadata service, smart contract templates and execution, and access control service to sidechains and their DApps.

The following services are included in the MMS Microservcies Core:

a. Service Registry

This Service is used to manage the metadata of management services. Service Registry Service will be acted as the Manager of the Manager (MoM) for MMS platform and will be responsible for services (including mainchain and sidechains) upgrade, rollout, triage and rollback. Also, any new services provided by MMS will be registered here with its metadata before the actual use. Services metadata will typically include service uuid, service symbol, service smart contract address, commission fee type (percentage or fix rate or dynamic lambda function), DApp DNS address and so on.

b. MMSS Metadata Service

This Service will be used to manage the metadata of each MMSS, such as fund raise, issuance, liquidation, authentication, real time exchange rate to MMS token and services using history.

c. Smart Contract Template and Execution Service

This service is two folded. First, smart contract template will store various templates of smart contract used for fund transaction or metadata modification.

Secondly, the Smart Contract Execution is used as decentralized data store for Smart Contract Execution DApp, such as DSL definition, execution container prerequisites and execution container package location.

d. Access Control Service

Used as decentralized data store for Access Control DApp.

We need to point out that the services modules above can also be treated as special sidechains so that each module can be further extended to add sub-sidechain functionalities.

By implementing the microservices core layer, we achieved the following benefits:
Technology Heterogeneity
Resilience
Scaling
Ease of Deployment
Organizational Alignment
Composability
Optimizing for Replaceability.

For example, when a sidechain A wants to perform an upgrade, the microservices layer helps A to achieve the upgrade goal by just upgrading the metadata information registered in the microservices, instead of whole sidechain A upgrade, hence greatly increases the efficiency.

### 1.3 Sidechain Layer

The sidechain layer is built on top of mainchain layer. It takes all of innovating features in the mainchain such as authentication and consensus mechanism, and makes use of microservice core to provide support for service DApps as well as customized token managements.

We define four different types of sidechains, namely, the built-in system service sidechain, the DAOS sidechain, ecosystem sidechain and consortium sidechain. We will address the detail of each kind of sidechain in the next section.

1.4 DApps Layer The DApps layer is built on top of sidechain layer. It provides various application services to investors such as media and legal services. Each DApps is decoupled, single-featured and has a corresponding sidechain as its data support.

### 2. MMS Sidechain Implementation

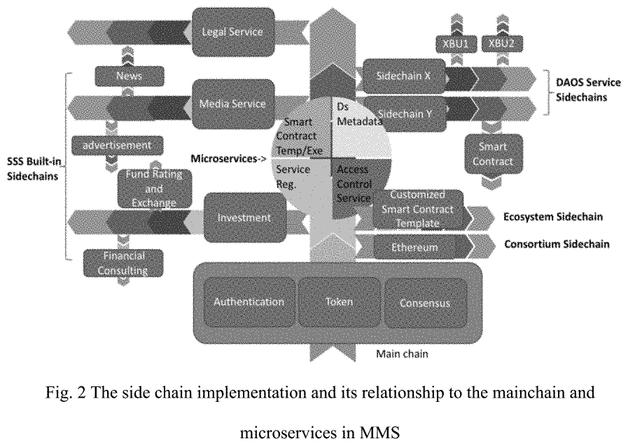

Referring now to the invention in more detail, in FIG. 2, shows the overview of side chain implemtation and its relationship to the mainchain and microservices core.

### 2.1 System Service Sidechain

System Service Sidechain (SSS) is a type of build-in sidechains in MMS platform to provide management service to support DAOS services. Each SSS has its corresponding DApp and used as a decentralized data store and lock store for its DApp. Currently, we have defined following SSSes, as illustrated in FIG. 2.

a. Fund Exchange Sidechain.

Used as decentralized data store for Fund Exchange Service DApp. Fund Exchange Service is used for fund exchange with MMS token.

b. Fund Rating Sidechain.

Used as decentralized data store for Fund Rating DApp.

c. Legal Service Sidechain

Used as decentralized data store for Legal Service DApp.

d. Media Service Sidechain

Used as decentralized data store for Media Service DApp.

e. Financial Consulting Sidechain

Used as decentralized data store for Financial Consulting DApp.

### 2.2 MMS Sidechain

MMS Sidechain (MMSS) is a type of sidechains that client created on MMS platform based on a smart contract. With a MMSS, client is able to use all of the services provided by MMS platform. A MMSS can be created with or without a new token. The exchange rate of which can be fixed or float to the token on MMS's mainchain, namely MMS token. Alternatively, client can also create a MMSS using MMS token as an exchanging currency. Eligible investors of each MMSS will exchange currency on MMSS itself. All of transactions will only be recorded in MMSS but not on the mainchain. As a result, MMSS will be a denotation of the organization willing to use MMS services as well as a physical blockchain used by Cryptocurrencies or Cryptocurrency derivatives created on MMS platform.

### 2.3 Ecosystem Sidechains

Ecosystem Sidechain (ES) is a sidechain that support DApps platform ecosystem. Currently, we have defined following ES.

a. Smart Contract Sidechain.

Different from Smart Contract Template Sidechain, this sidechain stores smart contract written by clients.

2.4 Consortium Sidechains All of sidechains described above are mounted to the mainchain. They are able to use various services and refined chain infrastructure provided by the mainchain. However, other public chain such as Ethereum can choose to form a consortium relationship with MMS so that members within the consortium can share common service such as creating exchanging currency. In this case, only service usages will be recorded on MMS as a separated MMSS.

### 3. MMS Operations

### 3.1 Cross-Chain Communication

Currently, Two-Way-Pegging[4] technique is widely used in blockchain community for cross-chain communication. However, with various fine-grained management services, MMS cross-chain communication is not necessarily be implemented in the chain level. Instead, DApps level with rich API choices can be a good place for some use cases. According to this, MMS will implement both chain level and DApps level communication with two types of cross-chain communication.

a. Metadata Modification Communication

Metadata modification communication is defined as MMSS or SSS chain metadata changes such as organization registration, fund raise, issuance, liquidation, service registration, service upgrade and so on. These operations are critical, less frequent and less efficiency requirement. For these operations, chain level cross-chain communication will be enforced by MMSS Metadata Service (MMSS metadata change) or Service Registry Service (SSS metadata change). MMS chain level cross-chain communication will use Two-Way-Pegging technique.

When MMSS Metadata Service or Service Registry Service receives these queries, it will initiate the transaction and do Two-Way-Pegging between the mainchain and the target sidechain. Once the transaction is confirmed in both chains, Fund Metadata Service or Service Registry Service will commit to its SSS to finished the whole transaction.

b. Service Oriented Communication

Service Oriented Communication is defined as data interactions involving DApps and microservice core such as fund rating query and legal service query. For these types of communication, DApps level communication would be a better choice than mainchain level communication.

First, SSS and ES typically do not have huge amount of hot data. This means their DApps can easily be adopt with cache. Depends on the requirements of DApps, Consistent Hashing [5], Memcached[6], Redis cluster[7] are all handy hashing techniques to have faster data access.

On the other hand, even though Two-Way-Pegging only works on chain level, it requires mainchain as a third-party communicator and chains need to wait for the creation of couple of new blocks to make sure the transaction is acknowledged. Moreover, sidechains are locked at this time until the whole transaction is completed. Finally, MMS as a completed platform, all of these data exchanges information will eventually be synced up with DApps. However, if transaction happens in the DApps level, syncing with DApps will be simplified; most of queries will be hit by cache; queries which needed to be committed on both side can commit individually with application level retry.

In MMS, cross-chain communication between DSs are discouraged due to the fund isolation. This means at least one side of transactions are cache manageable. Thus DApps level communication should be consider first.

### 3.2 Fund Management

As mentioned above, fund in MMS is an abstraction of MMSS plus its metadata (including smart contract).

a. Fund Creation and Exchange Rate

Fund creation will be initiated by clients on MMS platform. Once MMSS Metadata Service receive the request, it will generate smart contract based on clients' fund raise application or directly use clients' customized smart contract. Then MMSS Metadata Service will create a sidechain using Two-Way-Pegging and execute the smart contract for creation.

Note that MMS's smart contract for fund will also include exchange rate. Whether a new fund using fixed exchange rate to MMS token or not is also configurable by user.

For floating exchange rate fund, same amount of MMS token will be transferred from mainchain to the new fund chain upon creation. This is like ICO on Ethereum. When liquidating the fund, any MMS token left should be transferred back to mainchain.

Fixed exchange rate fund is almost the same, but new token is just a notation with exchange rate to MMS token recorded in the smart contract. All of actual transactions will be the same as exchange MMS token on the mainchain.

b. System Service Request

Fund user will be able to request system service at any time. The communication will through DApps level. There are following steps:
1) Service Registry get the request and find the actual System Service and its smart contract.
2) System Service will query MMSS Metadata Service to get fund metadata.
3) With fund metadata and smart contract, System Service will perform local service if necessary and pack required data and send to Smart Contract Execution Service to execute the smart contract.
4) Once smart contract is executed and acknowledged. Smart Contract Execution

Service will inform System Service and MMSS Metadata Service to commit the change separately.

Note that each step above will check DApps cache first and skip costly operation in case of cache hit.

c. Commission Fee

There will be two kinds of commission fee, one written in smart contract and used to pay System Services. This kind of commission fee will be defined either by the percentage of transaction amount or by a fixed rate. All of the SSS commission fee will be enforced when service request creating a new block on SSS.

The other commission fee is defined as fund trading commission fee. Each fund trade transaction will need to pay commission fee to MMS platform as well as the fund management organization. The amount of the commission fee is written in the smart contract as a fixed rate along with a split ratio to pay MMS platform. Whenever a new block created in MMSS, commission fee will be enforced as part of consensus algorithm. Commission fee will originally be generated as the sidechain token. And will pay to the fund management organization according to the split ratio right away. The rest part of commission fee will be handled by Fund Exchange Service in a batch job and return to MMS platform as MMS token.

d. Smart Contract Execution

To provide a secure and robust platform, MMS will use container to perform most of smart contract and service executions. Smart Contract Execution service have container template for each service and have an interface to dynamically insert customized smart contract. Each container execution environment will only be readable by users in access control list. Users will not have write permissions to the container, all of the user interactions should through the smart contract.

e. Access Control

In MMS platform, access control is more on system service availability. Most of fund are managed by a group of users and Access Control Service will make MMS platform be able to provide different levels of service for different users within one fund group.

While the foregoing written description of the invention enables one of ordinary skill to build and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A method of providing robust, efficient and high speed public blockchain service via new Micoservices based Mainchain/Sidechain (MMS) architecture, comprising:
Layer 1: Mainchain layer;
Layer 2: Microservices core layer;
Layer 3: Sidechains layer;
Layer 4: Dapps layer; and
MMS operations.

2. The method of claim 1, wherein the mainchain layer includes an authentication mechanism Module for cryptophytic purpose, consensus module to achieve consensus, and token module for token services.

3. The method of claim 1, wherein the Microservices core layer includes Service Registry to manage the metadata of management services.

4. The method of claim 1, wherein the Microservices core layer also includes MMS sidechain (MMSS) Metadata Service to manage the metadata of each

5. The method of claim 1, wherein the Microservices core layer also includes Smart Contract Template and Execution Service to store various templates of smart contract, and is used as decentralized data store for Smart Contract Execution DApp, such as DSL definition, execution container prerequisites and execution container package location.

6. The method of claim 1, wherein the Microservices core layer also includes Access Control Service to serve as decentralized data store for Access Control DApp.

7. The method of claim 1, wherein the Sidechains layer includes System Service Sidechain to provide management service to support MMS services.

8. The method of claim 1, wherein the Sidechains layer also includes MIMS sidechain (MMSS) for client to use all of the services provided by MMS platform.

9. The method of claim 1, wherein the Sidechains layer also includes Ecosystem Sidechains that support DApps platform ecosystem.

10. The method of claim 1, wherein the Sidechains layer also includes Consortium Sidechains which other public chain such as Ethereum can choose to form a consortium relationship with, so that members within the consortium can share common service such as creating exchanging currency.

11. The method of claim 1, wherein the Dapps layer provides various application services to investors such as media and legal services.

12. The method of claim 1, wherein the MMS operations include Cross-chain communication to provide both chain level and DApps level communications via Two-Way-Pegging, which further includes Metadata Modification Communication and Service Oriented Communication.

13. The method of claim 1, wherein the MMS operations include Fund Management, which further include Fund Creation and Exchange Rate, System Service Request, Commission Fee, Smart Contract Execution, and Access Control.
